(19) United States
(12) Patent Application Publication
(10) Pub. No.: US 2013/0192979 A1
(43) Pub. Date: Aug. 1, 2013

(54) APPARATUS FOR PLASMATIZING SOLID-FUEL COMBUSTION ADDITIVE AND METHOD FOR USING THE SAME

(71) Applicants: Weili Xu, Wuxi (CN); Heguang Zhu, Mississauga (CA)

(72) Inventors: Weili Xu, Wuxi (CN); Heguang Zhu, Mississauga (CA)

(73) Assignee: GREENVILLE ENVIROTECH CO LTD, SHENZHEN (CN)

(21) Appl. No.: 13/825,702

(22) PCT Filed: Jan. 17, 2011
(86) PCT No.: PCT/CN11/70314

§ 371 Date: Mar. 22, 2013

(51) Int. Cl. H05H 1/48

(52) U.S. Cl. CPC H05H 1/48
USPC 204/164; 422/186.21

(57) ABSTRACT

An apparatus for plasmatizing solid-fuel combustion additive and the method for using the same are provided. The apparatus is made from a reaction vessel, electrodes, a power supply, a carrier gas intake device, a feed device and an outlet of the plasmatization reaction vessel. The method to use this apparatus is as following: The additive is added into the reaction vessel through the feed device in which the carrier gas passes and carries the additive into the electrode region for evaporation and (partially) plasmatization; and the plasmatized gas from the outlet of the reactor is introduced into any combustion chamber. The additive is an organometallic compound or a mixture of the organometallic compounds, or their derivative, eutectic compound or coordination agent containing at least one organometallic compound. The present invention provides a method for plasmatizing combustion additive, then the plasmatized combustion additive is added into the combustion system to participate the combustion reaction between fuel and oxygen, in turn, to improve the utilization efficiency of the additive, reduce the amount of the additive used, improve the combustion efficiency and quality of the flue gas, then to save the fuel and reduce the emission of the gaseous contaminates.

### BACKGROUND

1. Technical Field

The present invention relates to an addition method of a combustion additive for solid fuels which include coal, urban organic wastes, and biomass, etc., and in particular, to the application of a plasmatization method of the combustion additive.

2. Related Art

In a combustion system of solid fuel, combustion additives may be added to improve the efficiency and quality of the combustion, and to reduce the emission of harmful gases, and the scaling and corrosion. Those combustion systems include boiler, engine, turbine, etc. Combustion catalysts are the most important type among those combustion additives; organometallic compounds, with bis(cyclopentadienyl) iron (commonly known as ferrocene) and methylcyclopentadienyl manganese tricarbonyl (MMT) as the representatives, are very important group among those combustion catalysts. Magnesium carboxylate or magnesium sulfonate is often added to the combustion system as a corrosion inhibitor.

Ferrocene, as a typical combustion catalyst, is a pale yellow solid at the ambient temperature. Since ferrocene can be easily dissolved in liquid fuel. In a conventional method, ferrocene is directly added to fuel, for example, in the case of adding ferrocene to gasoline. By adding ferrocene to gasoline, the octane number of gasoline is increased, and the exhaust emissions and fuel consumption of vehicles that use such gasoline can be reduced [1]. U.S. Pat. No. 4,389,220 discloses that ferrocene is added to a diesel engine combustion system through a two-stage method, which includes: at an initial stage, adding ferrocene of a concentration of 20 to 30 ppm to diesel, so as to reduce the carbon deposition in the combustion chamber and form a layer of catalytic iron oxide on a surface of the combustion chamber; at a subsequent maintenance stage, adding ferrocene of 10 to 15 ppm, so as to maintain the iron oxide coating. At the latter stage, if ferrocene of the same concentration as that of the initial stage is added, the improvement on the combustion is decreased, and the catalytic effect of the catalytic iron oxide coating on the wall of the combustion chamber is decreased. In some examples, ferrocene is directly mixed with solid fuel for use, for example, in the case of adding ferrocene to a solid rocket propellant. U.S. Pat. No. 3,927,992 sets forth that 0.001 wt % to 5 wt % cyclohydrocarbyl metallic compound solid combustion catalyst such as ferrocene and methylcyclopentadienyl manganese tricarbonyl is directly mixed with pulverized coal or mould coal to improve the combustion efficiency and reduce the concentration of carbon and SO₃ in the fume, and this patent also sets forth that the catalyst is pre-dissolved in a distillate fuel and then mixed with pulverized coal or mould coal for combustion.

For organometallic compound fuel additives such as ferrocene which is easy to sublimate, it can be evaporated at certain rate if its temperature is higher than the ambient temperature (for example 38° C.). For this reason, a method that first heats and vaporizes it to a vapor form, then add it to fuel or the air to enter the combustion system is adopted in the practices. For example, U.S. Pat. No. 2,867,516 sets forth that pre-heated gaseous hydrocarbon fuel or the air or oxygen passes through a ferrocene crystal bed to evaporate ferrocene, and then the evaporated ferrocene is mixed with a mixture of fuel and air. With this method, the concentration of ferrocene can be controlled in a range of 0.05 wt % to 5 wt %; and if the concentration of the ferrocene is suitable, the quality of combustion is significantly improved with a generation of much clean combustion products. U.S. Pat. No. 5,113,804 sets forth that a palladium-containing solid combustion catalyst is dispersed on a heating plate, by this way, the catalyst is sublimated and added into the air for combustion. The amount of the catalyst added is adjusted by various parameters including the consumption rate of the fuel or the generation rate of a combustion product. U.S. Pat. No. 5,235,936 sets forth that ferrocene is added to a special evaporation chamber equipped with a heating device, and the sublimation of ferrocene in the vessel is controlled through the temperature of the vessel; when the air flows through out of the evaporation chamber, the diffused ferrocene vapor is drawn into the gaseous phase through an opening of the evaporation chamber and then participates in the combustion reaction. Although U.S. Pat. No. 3,927,992 dose not disclose the details for evaporating the combustion catalyst, it discloses that the addition of the vapor of such type of catalyst into the primary air or secondary air can promote the combustion.

As mentioned above, the method that a combustion additive is first dissolved in a certain liquid fuel or solvent, and then sprayed into a solid fuel or a combusting gaseous phase (the primary and secondary air or the combustion chamber) is also often considered. For example, U.S. Pat. No. 3,927,992 discloses that methylcyclopentadienyl manganese tricarbonyl (MMT) is formulated into a 0.14 lb/gal distillate fuel solution and then sprayed into a combustion system.

It is obvious that, the effect of the organometallic compounds such as ferrocene and MMT on improving the combustion is influenced by the properties of the fuel, the addition methods of the fuel and the combustion process; it is also greatly influenced by the addition amount and methods of themselves. There are many limitations for the various current addition methods of the combustion additives. For solid fuel such as coal and municipal waste, for example, since the addition amount is so small, uniformly mixing of the additive and the fuel can not be achieved if the additive is directly added. Using the method that the additive is first dissolved in liquid fuel oil or solvent and then spraying the oil or solvent to the fuel, the mixing condition can be improved to a certain extent, however it is possible that the additive and the fuel still cannot be mixed completely because of the small amount of the additive added. For some organometallic additives with high toxicity, adopting the method of spraying may cause great harm to the health of the operating personnel. When passing through a pulverizing machine, some organometallic compounds that are easily sublimated or decomposed may be sublimated and lost or decomposed into metal oxides and aggregated together in advance, this way the dispersed state of the organometallic compound molecules cannot be maintained, it will cause the increase of additive consumption. Some additives such as MMT are very sensitive to light. They can be decomposed in a few seconds of light irradiation. This brings difficulties to actual practice. If the additives are first dissolved in liquid fuel oil or solvent and then sprayed to the primary or secondary air or the combustion chamber, explosive vapors may be formed, it could cause some safety issues. Since the solubility of the organometallic compounds in common fuel oil or solvent is low (below 10%), a large amount of those oils or solvents is needed if this type of addition method is used, thereby additional cost of the oil and solvent will be incurred plus the inconvenience in operation.

It is a relatively effective method to evaporate the organometallic compound additives by utilizing their characteristic of being easily sublimated, and added into the gaseous phase. However, this method also has disadvantages. For example, the boiling point of ferrocene is 249° C., complete gasification needs high temperature; on the other hand, the sublimation at low-temperature is affected by the surface area of the ferrocene bulk, and the conditions of convection, pressure and temperature, therefore it is difficult to control the actual addition quantity. The amount of ferrocene added can be controlled to certain extent by controlling the flow rate of the air passing through a ferrocene bed, but accurate metering cannot be easily achieved. Moreover, the adjustment of the additive quantity according to the data of monitoring combustion performance depends on a reliable real-time monitoring system, which is difficulty to implement in engineering if this method is used.

More importantly, among the already known combustion additives, only ferrocene can be added through sublimation, other additives are particles in crystal form or droplet state, and after being added into the combustion system they are first converted into free molecules, then their functions can be exerted. This conversion causes the increase of the reaction time, and at the same time results in uneven distribution of the additives, thereby the increase of their amount needed. Even for ferrocene which is added through sublimation, it is added in a free molecular state, not the free metal ions, metal oxides and other free radicals which are generated by decomposition of the ferrocene molecule and subsequent reaction process. It is those metal ions, oxides and free radicals which actually have the catalytic effect. The decomposition of ferrocene also takes some time and causes certain extent of delay for catalysis, thereby weakened the exertion of catalytic effect of ferrocene.

Plasma is a state of matter similar to gas, in which a part of molecular or atom particles is ionized. “Ionization” means that at least one electron is lost or obtained by an atom or molecule, and the atom or molecule is then positively or negatively charged. As the temperature rises, the energy of the molecule in the matter increases, and the phase of the matter changes in sequent from solid to liquid then to gas, then to plasma state. The plasma state is therefore often called the fourth state of matter in physics.

The presence of free charges (electrons and ions) makes the plasma electrically conductive (and the conductivity even exceeds gold and copper), high active, and very sensitive to electromagnetic fields. It is estimated that, in the visible universe, the matter existing in the form of plasma accounts for 99% or more of the total amount of all matter.

### BRIEF DESCRIPTION OF THE INVENTION

Focusing on the defects of the prior art, the present invention is to provide a method for plasmatizing a solid-fuel combustion additive, in which the carrier gas flow and the quantity of the combustion additive are controlled, therefore the combustion additive are precisely added to the solid fuel combustion process in an adjustable and controllable manner to participate in the reaction between the fuel and oxygen. The further purpose of the invention is to improve the efficiency of the additive utilization and therefore the combustion, save the additive and fuel used, and reduce the emission of gaseous pollutants.

The objectives of the present invention are realized by the following technical solutions. An apparatus for plasmatizing solid-fuel combustion additive (a plasma reactor) is provided. The apparatus is composed of:

A reaction vessel, mainly for housing the plasma reaction and the installation of the electrodes, the carrier gas intake device and the additive feed device;

Electrodes, including a cathode and an anode, fixed inside the reaction vessel or in the inner wall of the vessel. The cathode and anode are respectively connected to the cathode and anode of a high-voltage power supply (when a DC is used, a ground electrode can server as the anode). The set-up of the electrodes must ensure that all or most of a carrier gas that enters the reaction vessel passes through the space between the electrodes (the electrode region). The voltage formed between the two electrodes is in the range of 3 to 150 kV. The energy of free electrons formed by discharge is in the range of 0.9 to 20 eV, and the electronic density is generally 10⁶ to 10¹⁸ cm⁻³;

A power supply, for providing power and a desired voltage for the electrodes;

A carrier gas intake device, which includes a gas source set out of the reaction vessel and an intake connection which introduces the carrier gas into the reaction vessel. The set-up of the carrier gas intake device should ensure that all or most of the carrier gas that enters the reactor passes through the space between the electrodes;

A feed device, for enabling a solid or liquid additive to uniformly enter the electrode region of the reactor or the plasma reaction region next to the electrode region, and to be fully mixed with the carrier gas that passes through the electrode region. The electrode region refers to the space between the two electrodes, and the plasma reaction region next to the electrode region refers to the space in the reaction vessel and right connected to the electrode region where the plasma exists and reacts with the additive;

An outlet of thereaction vessel, for introducing the plasmatized additive into the combustion chamber.

In the said apparatus for plasmatizing solid-fuel combustion additive, the material of the reaction vessel may be glass, ceramic, steel, plastics or a composite material, and the shape can be a cylinder, a sphere, a cubic, a rectangular or flate cubic, or any shape suitable for plasmatizing the additive.

In the said apparatus for plasmatizing solid-fuel combustion additive, the electrodes can be a single pair of electrodes, and may also be multiple pairs of electrodes.

In the said apparatus for plasmatizing solid-fuel combustion additive, the power supply is a high-voltage one which uses a direct current (DC) or an alternating current (AC) electricity.

In the said apparatus for plasmatizing solid-fuel combustion additive, a distribution device may be set in the reaction vessel for uniformly distributing the additive that enters the electrode region or the plasma reaction region through the feed device.

In the said apparatus for plasmatizing solid-fuel combustion additive, its feed device uses a part of the carrier gas to carry the additive to enter the electrode region or the plasma reaction region for plasmatization.

In the said apparatus for plasmatizing solid-fuel combustion additive, the feed device is set in the path of the carrier gas, so that the additive enters the carrier gas path and the reactor together with the carrier gas.

In the said apparatus for plasmatizing solid-fuel combustion additive, the high voltage discharge occurred between the electrodes that installed in the reaction vessel or on the inner wall of the reaction vessel, can take a form of, but not limited to, plasma torch discharge, gliding arc discharge, corona discharge or dielectric barrier discharge.

As part of the method using the apparatus for plasmatizing solid-fuel combustion additive, the said additive that is added into a reaction vessel through the feed device and enters the electrode region or the plasma reaction region is an organometallic compound or a mixture of two or more organometallic compounds, or their derivatives.

In the method for using the apparatus for plasmatizing a solid-fuel combustion, the said additive organometallic compound contains one metal element from the following group of the metal elements: iron, manganese, platinum, titanium, chromium, palladium, nickel, vanadium, cerium, lanthanum, copper, zinc, yttrium, zirconium, niobium, molybdenum, tin, antimony, magnesium, tungsten or osmium.

In the method for using the said apparatus for plasmatizing solid-fuel combustion additive, the additive is in solid or liquid phase in ambient temperature, and is commonly added directly in a form of pure reagent; it can also be added as a mixture with any solvent or entraining reagent. The commonly used solvent or entraining reagent includes pulverized coal, coal ash, water, gasoline, diesel, heavy oil, aviation fuel, solvent oil, aromatics, dimethyl formamide, tetrahydrofuran, isopropanol, petroleum ether or ethyl acetate.

In the method for using the said apparatus for plasmatizing a solid-fuel combustion additive, the said carrier gas that enters the reaction vessel through the carrier gas intake device can be air, water vapor, oxygen, argon, carbon dioxide, flue gas or a mixture thereof.

Compared with the prior art, the present invention has the following advantages:

(1) In the plasmatization apparatus of the present invention, a solid-fuel combustion additive can be conveniently, flexibly and accurately added to the feed (mixture of primary air and fuel) or secondary air. It can also be directly added into combustion chamber through the auxiliary fuel inlet or a specialized nozzle to completely contact with the primary and secondary flames. The installation of the system has no need to re-construct the original combustion system. The addition amount can be metered accurately, and the quantity and quality of the additive added can be adjusted by controlling the carrier gas flow rate, the electrical voltage and the actual amount of the addition, therefore the optimization of the additive addition under different combustion conditions cab achieved.

(2) No other liquid fuel or solvent is used to pre-dissolve or pre-dilute the additive, so that the cost is reduced.

(3) The combustion catalyst is of the most importance among different types of combustion additives. Because it is the free metal ions, metal oxide and free radicals converted from the metallic compound that are actually served as the catalyst during the combustion reaction, in the present invention, the combustion catalyst is not only evaporated but also partially or completely ionized, excited or activated after being treated in the apparatus, therefore the particles with high catalytic activity are generated, the catalytic reaction is carried out more fast, the utilization efficiency of the catalyst is significantly improved, and the amount of the catalyst consumed is reduced.

(4) Some organometallic compounds that are stable under ordinary conditions are normally not suitable for being used as a combustion additive, due to their strong chemical bonds. These organometallic compounds can be easily ionized into free metal ions by using the apparatus in the present invention, thereby the range of option for the metallic compounds for the combustion additives is widened, therefore the cost of the additive can be reduced.

(5) By adding the combustion additive using the present invention, together with the choosing of the carrier gas, the harmful pollutants such as carbon particles, SOx and NOx generated during the combustion can be eliminated effectively.

(6) An even metal oxide layer is formed on the inner wall of the combustion chamber after the combustion additive is plasmatized, thereby achieving a continuous catalyzing of the combustion.

### BRIEF DESCRIPTION OF THE DRAWINGS

The following figures and their brief description are only intended for the present disclosure to be more fully understood, thus not to limit the present disclosure.

FIG. 1 is a schematic view of the apparatus for plasmatizing solid-fuel combustion additive included in the present invention, in which the high-voltage discharge between the electrodes is gliding arc discharge;

FIG. 2 is a schematic view of the apparatus for plasmatizing solid-fuel combustion additive included in the present invention, in which the high-voltage discharge between the electrodes is corona discharge;

FIG. 3 is a schematic view of the apparatus for plasmatizing solid-fuel combustion additive included in the present invention, in which the high-voltage discharge between the electrodes is dielectric barrier discharge (tubular electrodes are used);

FIG. 4 is a schematic view of the apparatus for plasmatizing solid-fuel combustion additive included in the present invention, in which the high-voltage discharge between the electrodes is dielectric barrier discharge (plate electrodes are used);

FIG. 5 is a schematic view of the apparatus for plasmatizing solid-fuel combustion additive included in the present invention, in which the high-voltage discharge between the electrodes is plasma torch discharge;

FIG. 6 is a schematic view of the apparatus for plasmatizing solid-fuel combustion additive included in the present invention, in which the high-voltage discharge between the electrodes is plasma torch discharge and the feed device is installed in the carry gas path.

### DETAILED DESCRIPTION

The present invention provides a non-equilibrium or non-thermal plasmatization apparatus, which can be used to add various organic combustion additives. The combustion additive of the present invention includes, but not limited to, an organometallic combustion catalyst, an organometallic corrosion inhibitor, and an organometallic compound scale inhibitor.

The organometallic combustion catalyst includes various cyclohydrocarbyl organometallic compounds and other organometallic compounds. Typical cyclohydrocarbyl organometallic compounds include cyclohydrocarbyl iron compounds AFeA′ and cyclohydrocarbyl manganese compounds AMn(CO)₃. In the general formulas of the cyclohydrocarbyl metallic compounds, A and A′ are any cyclopentadienyl groups containing 5 to 13 or more carbon atoms; these groups consist of carbon and hydrogen atoms, and have a monocyclic, bicyclic or tricyclic chemical structure. The representative organometallic catalysts are: dicyclopentadienyl iron (ferrocene), bis(methylcyclopentadienyl) iron (dimethylferlxicene), or methylcyclopentadienyl manganese tricarbonyl, carboxylic lanthanum, cerium naphthenate, iron naphthenate, nickel carbonyl.

The said metal element in the organometallic combustion additive can be any of iron, manganese, platinum, titanium, chromium, palladium, nickel, vanadium, cerium, lanthanum, copper, zinc, yttrium, zirconium, niobium, molybdenum, tin, antimony, magnesium, tungsten or osmium. Among these metal elements, the transition and rare earth elements are more frequently used in the combustion additive than precious metals because they have an empty d orbital which is easier to form bonds with other element and a greater charge/radius ratio, a higher activity and a lower cost than the precious metals.

The organometallic combustion additives which can be used in the present invention further include the mixtures, derivatives, eutectic compounds or coordination compounds of the organometallic compounds aforementioned, for example, derivatives of ferrocene, 1,3-diferrocenyl-1-butene.

The organometallic combustion additives which can be used in the present invention further include other combustion additives containing any of the organometallic compounds.

The said combustion additives which can be used in the present invention further include metallic combustion additives containing any metal element, provided that free metal ions and metal oxides can be generated after the additives are plasmatized.

The combustion additives which can be used in the present invention are solid or liquid at the ambient temperature. They are directly added in the form of pure agent, or are added as a mixture with any solvent or entraining agent. The commonly used solvent or entraining agent includes pulverized coal, coal ash, water, gasoline, diesel, heavy oil, aviation fuel, solvent oil, aromatics, dimethyl formamide, tetrahydrofuran, isopropanol, petroleum ether or ethyl acetate.

The plasmatization apparatus of the present invention is in principle a plasma reactor, which is composed of a reaction vessel, a carrier gas intake device, electrodes, a power supply and a solid feed device. The reaction vessel may be made of glass, ceramic, steel, engineering plastics or any other suitable material, and its shape can be a cylinder, a vertical rectangular cubic or any other shape.

The carrier gas inlet is attached on the wall of the vessel or inserted into the reaction vessel to reach any position through pipe. The inlet may be a single entrance or composed of multiple entrances. The electrodes are fixed on the wall of the reactor or at any position in the reactor, and are arranged to ensure that all or most of the carrier gas entering the reactor can pass through the space between the electrodes. The electrodes may be made of a single pair of electrodes, and may also be made of multiple pairs of electrodes or an electrode module made from multiple electrodes. The cathodes and anodes are respectively connected to the two poles of the high-voltage power supply, and when a DC is used, a ground electrode can server as the anode. There is a voltage of about 3 kV to 150 kV between the two electrodes. The high-voltage power supply can be a DC power supply, an AC power supply, or a pulsed DC power supply; and the high voltage or the high frequency plus the high voltage is generally generated from a AC electricity (90 to 240 V) through a transformer unit. The feed device is generally installed at the top or the side of the reactor, so that the solid or liquid additive can be evenly added to the electrode region or the plasma reaction region adjacent to the electrode region, and the feed device may also be installed in the path of the carrier gas, so that the additive can enter and be mixed with the carrier gas, and then enters the reactor together with the carrier gas for evaporation and plasmatization. Another option for the manufacturing and installation of the feed device is to drive a portion of the carrier gas into the feed device to carry the additive, so that the additive can enter the electrode region or the plasma reaction region for gasification and plasmatization.

No matter which type of electrodes is used, an electric field is formed and a type of discharge is occurred between the cathode(s) and anode(s), and the energy (electron temperature) of the free electrons generated by the discharge is in the range of 0.9 to 20 eV (and generally about 1 eV), and the electron density is generally 10⁶ to 10¹⁸ cm⁻³. Under the effect of the electric field and the high-energy electrons, plasma is generated from the carrier gas. When the combustion additive is added to the electric field region or plasma region, it is evaporated/gasified instantaneously under the effect of electrons and other charged ions, or excited/activated atoms or molecules. During this gasification or plasmatization, some ions or excited/activated molecules that can promote the combustion are generated; these components evaporated/ionized/excited/activated from combustion additive and the other excited/activated particles that are generated from the carrier gas enter the combustion chamber, and are completely mixed, contact and collide with the gasified fuel molecules or the fuel particles to be gasified and the oxygen, so that the efficiency and the quality of combustion can be improved, at the same time, the utilization efficiency of the fuel can be improved, and the amount of carbon particles and other pollutants in the fume can be reduced.

The carrier gas can be the air, vapor, oxygen, argon, carbon dioxide, flue gas or a mixture thereof, and preferably the air or flue gas. The selection of the carrier gas depends on the improvement of the combustion efficiency and the reduction of the concentration of the pollutants in the fume generated.

The high-voltage discharge between the electrodes may be a plasma torch (a plasma arc, a plasma gun, or a plasma jet) discharge, gliding arc discharge, corona discharge or dielectric barrier discharge.

In order to prevent the evaporated and plasmatized additive components from depositing in the pipe due to quenching, the addition spot needs to be as close to the combustion flame as possible, and the distance between the gasification unit and the addition spot needs to be as short as possible, and at the same time, corresponding insulation measures need to be applied to the pipe between the gasification unit and the addition point.

### EMBODIMENT 1

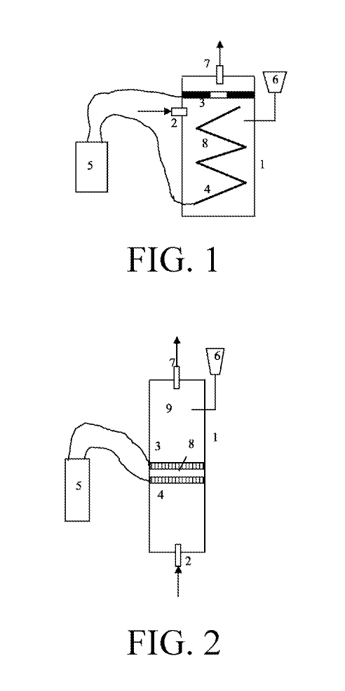

FIG. 1 is a schematic diagram of one embodiment of the apparatus for plasmatizing solid-fuel combustion additive of present invention. In this set-up, the high-voltage discharge between electrodes employs a gliding arc discharge. In this embodiment, the carrier gas with certain velocity enters the reaction vessel in tangential direction, the velocity of the carrier gas flow needs to be high enough (for example, about 10 m/s) to form a gas swirl in the reaction vessel, and the gas in the swirl state enters the electrode region, thereby the plasma is generated and a gliding arc is formed in the electrode region. The plasma generated and the combustion additive entered in the electrode region contact with each other, and energy exchange occurs between the plasma and the combustion additive, so that combustion additive is rapidly evaporated and partially plasmatized. The resulted vapors and plasma leave the reaction vessel through the outlet of the plasma reactor under the driving of the carrier gas, and enters the combustion system. In FIG. 1, 1 represents the reaction vessel, 2 represents the gas intake device, 3 represents the cathode, 4 represents the anode, 5 represents the power supply, 6 represents the feed device, 7 represents the outlet of the plasma reactor, and 8 represents the electrode region.

The detailed operation process of this embodiment is described as following. The air (the carrier gas) enters the electrode region 8 formed between the cathode 3 and the anode 4 in the reaction vessel 1 in a tangential direction at a velocity of 10 m/s through the gas intake device 2. The power supply 5 uses a 220 V AC electrical power, and the input power is transformed by a built-in transformer unit to generate a high voltage of 50 kV; the high voltage power is applied two the electrodes to form a voltage of about 40 kV. Ferrocene is used as the catalytic combustion additive, and enters the reaction vessel 1 through the feed device 6 at an addition rate of 25 mg/kg standard coal. Under the effect of the high voltage the ferrocene becomes a type of plasmatized gas which can improve the combustion efficiency. The outlet 7 of the plasma reactor is connected to the feeding line (conducting the primary gas and pulverized coal) of a combustion system, so the plasmatized gas from the outlet 7 of the plasma reactor can be mixed with the primary gas and pulverized coal, and enter the combustion chamber for combustion. By using this embodiment, the catalytic efficiency of the combustion additive is improved by 350% as compared with the method employing spraying a liquid combustion additive.

### EMBODIMENT 2

FIG. 2 is a schematic diagram of another embodiment of the apparatus for plasmatizing solid-fuel combustion additive of present invention, in which the high-voltage discharge between electrodes is corona discharge. The carrier gas with certain flow speed enters the reactor through the bottom, and passes through the corona discharge region where the plasma is formed. The plasma generated contacts with the combustion additive entered in the plasma reaction region. Energy exchange occurs between the plasma and the combustion additive. The combustion additive is then rapidly evaporated and plasmatized, and leaves the reaction vessel through the outlet of the reactor under the driving of the carrier gas, and enters the combustion system.

In FIG. 2, 1 represents the reaction vessel, 2 represents the gas intake device, 3 represents the cathode, 4 is the anode, 5 represents the power supply, 6 represents the feed device, 7 represents the outlet of the plasma reactor, 8 represents the electrode region, and 9 represents the plasma reaction region.

The detailed operation process is described as following. The air is used as the carrier gas. Through the gas intake device 2, the air enters the reaction vessel 1 from the bottom at a flow velocity of 2 m/s, and passes through the electrode region 8 in axial direction. The power supply 5 uses a 220 V AC electrical power which is transformed by a built-in transformer to a high voltage of 120 kV. The high voltage is applied to electrodes 3 and 4. Ferrocene is used as the combustion additive, and the amount of the additive added is 25 mg/kg standard coal. The plasmatized gas from the outlet 7 of the plasma reactor mixed with the primary air and pulverized coal enter the combustion chamber for combustion. By using this embodiment, the catalytic efficiency of the combustion additive is improved by 400% as compared with the method employing spraying the liquid combustion additive.

### EMBODIMENT 3

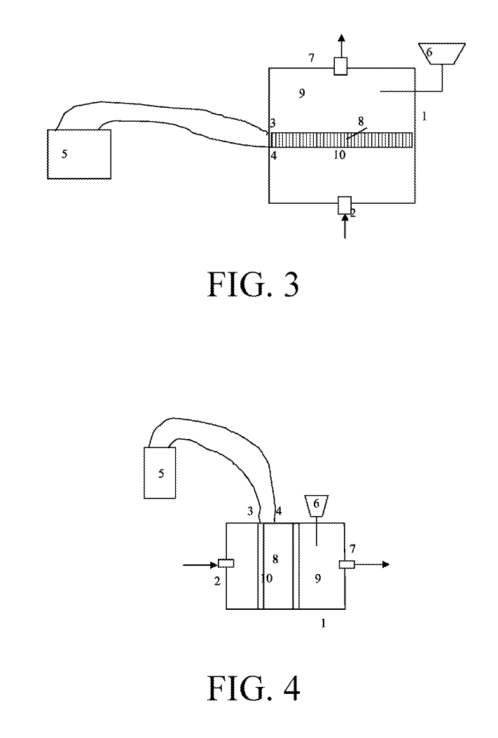

FIG. 3 and FIG. 4 are schematic diagrams of another embodiment of the apparatus for plasmatizing solid-fuel combustion additive of present invention, in which the high-voltage discharge between electrodes is dielectric barrier discharge. The carrier gas with certain flow velocity enters the reactor through the bottom or the side of the reactor, passes through a corona discharge electrode region, and forms the plasma. The plasma generated and the combustion additive entered contact with each other in the electrode and plasma regions; and the energy exchange occurs between the plasma and the combustion additive so the combustion additive is rapidly evaporated and plasmatized. The resulted plasma gas leaves the reaction vessel through the outlet of the plasma reactor under the driving of the carrier gas, and enters the combustion system.

In FIG. 3 and FIG. 4, 1 represents the reaction vessel, 2 represents the gas intake device, 3 represents the positive electrode, 4 represents the negative electrode, 5 represents the power supply, 6 represents the feed device, 7 represents the outlet of the plasma reactor, 8 represents the electrode region, 9 represents the plasma reaction region, and 10 represents a tube-shaped electrodes.

The detailed operation process is described as following. The air is used as the carrier gas. Through the gas intake device 2, the air with a velocity of 2 m/s enters the reaction vessel 1 from the horizontal direction, and passes through the electrode region 8. The power supply 5 uses a 220 V AC electrical power which is transformed by a built-in transformer unit to generate a high AC voltage of 120 kV. The high voltage is applied to the electrodes. Ferrocene is used as the combustion additive, and the amount of the additive added is 25 mg/kg. The plasmatized combustion assisting gas from the outlet 7 of the plasma reactor is mixed with the primary air and pulverized coal, and enters a combustion chamber for combustion. By comparing the catalytic efficiencies of a common industrial coal-fired boiler before and after using this embodiment, the latter is 110% of the former.

### EMBODIMENT 4

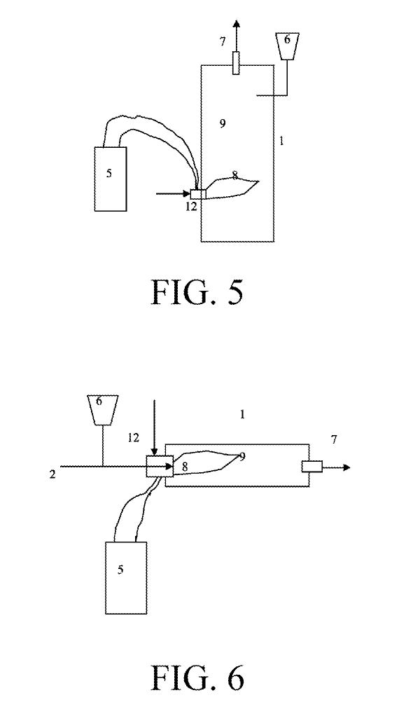

FIG. 5 is a schematic diagram of another embodiment of the apparatus for plasmatizing a solid-fuel combustion additive of present invention, in which the high-voltage discharge between electrodes is plasma torch discharge. The electrodes are installed inside the plasma torch nozzle, and the carrier gas with certain flow velocity passes through the space between the electrodes and forms a plasma flame at the outlet of the nozzle. The plasma flame is generally injected into the reactor from the side direction, and the plasma flame and the combustion additive enter the reactor from the upper portion of the reactor contact and react each other. The combustion additive is then rapidly evaporated and plasmatized, and leaves the reaction vessel through the outlet of the plasma reactor under the driving of the carrier gas, and enters the combustion system.

In FIG. 5, 1 represents the reaction vessel, 5 represents the power supply, 6 represents the feed device, 7 represents the outlet of the plasma reactor, 8 represents the electrode region, 9 represents the plasma reaction region, 12 represents the plasma torch nozzle which integrates the gas intake device 2, the cathode 3 and the anode 4.

The detailed operating process is described as following. The air is used as the carrier gas. Through the plasma torch nozzle 12, the air enters the electrode region installed in the torch nozzle from side direction at a velocity of 2 m/s, and then enters the reaction vessel 1. The power supply 5 uses a 220 V AC power which is transformed by a transformer unit built in the power supply to generate a high voltage of 50 kV; the high voltage power is applied to the electrodes. Ferrocene is used as the combustion additive, and the amount of the additive added is 30 mg/kg standard coal. The plasmatized gas from the outlet 7 of the plasma reactor enters a combustion chamber together with a mixture of the primary gas and pulverized coal. Comparing the situations before and after using the current embodiment of the apparatus, the catalytic efficiency of the coal is significantly improved and the residue carbon in the fume is significantly inhibited after using the apparatus.

### EMBODIMENT 5

FIG. 6 is a schematic diagram of another embodiment of the apparatus for plasmatizing solid-fuel combustion additive of present invention, in which the high-voltage discharge between electrodes is plasma torch discharge. The electrodes are installed inside the plasma torch nozzle, and a carrier gas with certain flow velocity passes through the space between the electrodes. The additive is carried from the center of the plasma torch nozzle to the edge of the outlet of the electrode region by an secondary carrier gas flow, and is mixed with the carrier gas that passes through the electrode region; the plasma flame is formed at the outlet of the nozzle. The plasma flame is generally injected into the reactor from one side of the reactor, and leaves the reaction vessel through the outlet on another side of the reactor, and enters the combustion system.

In FIG. 6, 1 represents the reaction vessel, 5 represents the power supply, 6 represents the feed device, 7 represents the outlet of the plasma reactor, 8 represents the electrode region, 9 represents the plasma reaction region, 12 represents the plasma torch integrating the gas intake device 2, the cathode 3 and the anode 4.

The detailed operation process is described as following. The air is used as the carrier gas. Through the plasma torch 12, the air with a speed of 1 m/s enters the electrode region installed in the torch nozzle from side direction and enters the reaction vessel 1. The combustion additive enters the edge of the outlet of the electrode region from the center of the plasma torch under the driving of the secondary carrier gas (air, too), and is mixed with the carrier gas from the electrode region. Energy exchange occurs between the combustion additive and the plasmatized carrier gas, and the plasma flame is formed. The power supply 5 uses a 110 V AC power which is transformed by a built-in transformer unit to generate a high voltage of 10 kV which is applied to the electrodes. Ferrocene is used as the combustion additive, and the amount of the additive added is 25 mg/kg standard coal. The plasmatized gas from the outlet 7 of the plasma reactor enters the combustion chamber for combustion together with a mixture of the primary gas and pulverized coal. By comparison of the situations before and after using the current embodiment, the combustion efficiency of coal is improved by 5% and the emission of black smoke is reduced by 50%.

Herein, we claim the following patent rights:

1. An apparatus for plasmatizing a solid-fuel combustion additive, which comprises:
a reaction vessel, mainly for providing the space for plasma reaction and for supporting the installation of the electrodes, the carrier gas intake device, the additive feed device and the outlet of the reaction vessel;
electrodes, including a cathode and an anode, fixed inside the reaction vessel or on the inner wall of the vessel. The cathode and anode are respectively connected to the cathode and anode of a high-voltage power supply. The set-up of the electrodes must ensure that all or most of a carrier gas that enters the reaction vessel passes through the space between the electrodes (the electrode region). The voltage formed between the two electrodes is in the range of 3 kV to 150 kV. The energy of free electrons formed by discharge is in the range of 0.9 to 20 eV, and the electronic density is generally 10⁶ to 10¹⁸ cm⁻³;
a power supply, for providing power for the electrode;
a carrier gas intake device, which includes a gas source set out of the reaction vessel and an intake connection which introduces the carrier gas into the reaction vessel. The set-up of the carrier gas intake device should ensure that all or most of the carrier gas that enters the reactor to passes through the space between the electrodes;
a feed device, for enabling a solid or liquid additive to uniformly enter the electrode region of the reactor or the plasma reaction region adjacent to the electrode region, and to be fully mixed with the carrier gas that passes through the electrode region; and
an outlet of the plasmatization reaction vessel, for introducing the plasmatized additive into the combustion chamber.

2. The apparatus for plasmatizing solid-fuel combustion additive according to claim 1, wherein the material of the reaction vessel is glass, ceramic, steel, plastics or a composite material, and the shape of the reaction vessel is cylindrical, spheric, cubic, rectangular cubic, flat cubic, or any shape suitable for plasmatizing the additive.

3. The apparatus for plasmatizing solid-fuel combustion additive according to claim 1, wherein the electrodes are a single pair electrodes or multiple pairs electrodes.

4. The apparatus for plasmatizing solid-fuel combustion additive according to claim 1, wherein the power supply is a high-voltage power supply, which can be a direct current (DC) power supply or an alternative current (AC) power supply.

5. The apparatus for plasmatizing solid-fuel combustion additive according to claim 1, wherein the reaction vessel has a distribution device for uniformly distributing the additive that enters the electrode region or the plasma reaction region adjacent to the electrode region through the feed device.

6. The apparatus for plasmatizing solid-fuel combustion additive according to claim 1, wherein through the feed device, a part of the carrier gas or a secondary carrier gas carries the additive and enters the electrode region or the plasma reaction region adjacent the electrode region for plasmatization.

7. The apparatus for plasmatizing solid-fuel combustion additive according to claim 1, wherein the feed device is installed in a path of the carrier gas, so that the additive enters the carrier gas path and then the reactor with the carrier gas.

8. The apparatus for plasmatizing solid-fuel combustion additive according to claim 1, wherein the high-voltage discharge occurred between the electrodes that are installed in the reaction vessel or attached on the inner wall of the reaction vessel, is, but not limited to, any of plasma torch discharge, gliding arc discharge, corona discharge or dielectric barrier discharge.

9. A method for using the apparatus for plasmatizing solid-fuel combustion additive according to claim 1, wherein the additive that is added to a reaction vessel by a feed device and enters the electrode region or the plasma reaction region next to the electrode region is an organometallic compound or a mixture, derivative, eutectic compound or coordination agent containing at least one organometallic compound.

10. The method for using the apparatus for plasmatizing solid-fuel combustion additive according to claim 9, wherein the metal element in the organometallic compound is iron, manganese, platinum, titanium, chromium, palladium, nickel, vanadium, cerium, lanthanum, copper, zinc, yttrium, zirconium, niobium, molybdenum, tin, antimony, magnesium, tungsten or osmium.

11. The method for using the apparatus for plasmatizing solid-fuel combustion additive according to claim 9, wherein the additive is a solid or liquid, and is directly added in the form of pure agent or mixture with any solvent or entraining agent for dilution. The commonly used solvent or entraining agent comprises pulverized coal, coal ash, water, gasoline, diesel, heavy oil, aviation fuel, solvent oil, aromatics, dimethyl formamide, tetrahydrofuran, isopropanol, petroleum ether or ethyl acetate.

12. The method for using the apparatus for plasmatizing solid-fuel combustion additive according to claim 9, wherein the carrier gas that enters the reaction vessel through the carrier gas intake device comprises the air, water vapor, oxygen, argon, carbon dioxide, flue gas or their mixture thereof.
